(19) United States
(12) Patent Application Publication
(10) Pub. No.: US 2015/0124776 A1
(43) Pub. Date: May 7, 2015

(54) DATA TRANSMISSION METHOD AND APPARATUS IN NETWORK LINKED WITH HETEROGENEOUS SYSTEM

(71) Applicant: Electronics and Telecommunications Research Institute, Daejeon (KR)

(72) Inventors: Hee Soo LEE, Daejeon (KR); Yu Ro LEE, Daejeon (KR); Chang Wahn YU, Daejeon (KR); Jong Ee OH, Daejeon (KR); Jae Woo PARK, Daejeon (KR); Sok Kyu LEE, Daejeon (KR)

(21) Appl. No.: 14/531,868

(22) Filed: Nov. 3, 2014

(30) Foreign Application Priority Data
Nov. 4, 2013 (KR) 10-2013-0133160

(51) Int. Cl. H04W 36/00

(52) U.S. Cl. CPC H04W 36/0022; H04W 36/0016
USPC 370/331

(57) ABSTRACT

Provided is a data transmission method and apparatus for maximizing data transmission efficiency by transmitting data through a flexible network transition in a network linked with a heterogeneous system.

### CROSS-REFERENCE TO RELATED APPLICATION

This application claims the priority benefit of Korean Patent Application No. 10-2013-0133160, filed on Nov. 4, 2013, in the Korean Intellectual Property Office, the disclosure of which is incorporated herein by reference.

### BACKGROUND

1. Field of the Invention

The present invention relates to a method and apparatus for transmitting data in a network linked with a heterogeneous system to maximize data transmission efficiency by transmitting the data through a flexible network transition, and more particularly, to a data transmission and reception method for improving a system performance in a case of using a cellular mobile communication network in conjunction with a wireless fidelity (Wi-Fi) network.

2. Description of the Related Art

A cellular mobile communication network has been used for continuously providing voice and data service to a mobile service user in a stationary or moving state, without time and location restrictions. A wireless fidelity (Wi-Fi) network has been used for providing wireless data service to a user in a stationary state, in general.

The cellular mobile communication network and the Wi-Fi network exist separately. Recently, developments in the two networks allow a service provider to provide mobile data service using the two networks, simultaneously.

Since the two networks use different bandwidths, distributed traffic processing may be possible.

However, a current method of using the two networks in conjunction involves processing traffic through distribution and thus, maximizing a performance in a case of using the cellular mobile communication network in conjunction with the Wi-Fi network is limited.

Accordingly, there is a desire for a data transmission and reception method for improving a system performance when the cellular mobile communication network is used in conjunction with the Wi-Fi network.

### SUMMARY

An aspect of the present invention provides a data transmission method and apparatus to minimize a delay occurring in a process of data transmission resulting from a network transition, and continuously exchange control information associated with an access process using a communication network unrelated to the data transmission without a disconnection occurring in a network liked with a heterogeneous system. Another aspect of the present invention also provides a data transmission method and apparatus to minimize wasted time in a subscriber information filing system (SIFS) by delivering acknowledgement (ACK) information using a communication network of which a reaction speed is relatively high, in response to data transmission in a network linked with a heterogeneous system.

Still another aspect of the present invention also provides a data transmission method and apparatus to perform data transmission of each terminal in a systemized state without congestion by providing scheduling information used for occupying the wireless resources for each terminal in a network linked with a heterogeneous system.

According to an aspect of the present invention, there is provided a data transmission method in a network linked with a heterogeneous system, the method including transmitting downlink data to a terminal device using a first communication network, and delivering, in response to a network transition request from the terminal device, control information used to connect the terminal device to a second communication network, to the terminal device using a channel associated with the first communication network while maintaining the transmitting of the downlink data using the second communication network differing from the first communication network.

According to another aspect of the present invention, there is also provided a data transmission apparatus including a mobile communication network server to transmit downlink data to a terminal device using a first communication network, a wireless fidelity (Wi-Fi) network server to maintain transmission of the downlink data to the terminal device based on a second communication network differing from the first communication network in response to a network transition request of the terminal device, and a control unit to transmit, to the terminal device, control information used to connect the terminal device to the second communication network using a channel associated with the first communication network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a relationship in a network adopting a data transmission apparatus according to an embodiment of the present invention;

FIG. 2 is a diagram illustrating an example of a data transmission apparatus according to an embodiment of the present invention;

FIG. 3 is a diagram illustrating another example of a data transmission apparatus according to an embodiment of the present invention;

FIG. 4 is a diagram illustrating still another example of a data transmission apparatus according to an embodiment of the present invention; and

FIG. 5 is a flowchart illustrating a data transmission method in a network liked with a heterogeneous system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

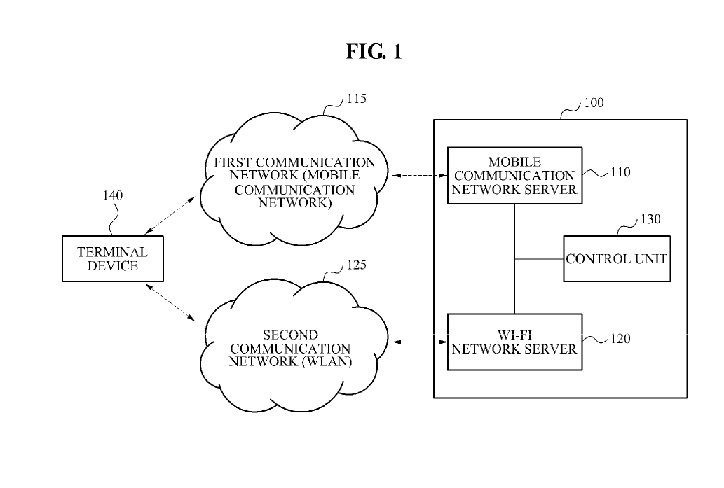

FIG. 1 is a diagram illustrating a relationship in a network adopting a data transmission apparatus 100 according to an embodiment of the present invention.

Referring to FIG. 1, the data transmission apparatus 100 may be selectively connected to a first communication network 115 and a second communication network 125, and transmit downlink data to a terminal device 140. The first communication network 115 may be a fee-charging mobile communication network such as a cellular mobile communication network including a third generation (3G) network, a long term evolution (LTE) network, and the like. The second communication network 125 may be a free mobile communication such as a wireless fidelity (Wi-Fi) network including a wireless access point (AP) and the like.

A mobile communication network server 110 may be included in the data transmission apparatus 100, and transmit the downlink data to the terminal device 140 using the first communication network 115. For example, the mobile communication server 140 may be connected to the terminal device 140 and transmit data to the terminal device 140 in response to a request from the terminal device 140 in a fee-charging environment of the cellular mobile communication network.

Subsequently, the data transmission apparatus 100 may verify whether a network transition request is received from the terminal device 140 while the downlink data is being transmitted to the terminal device 140.

The network transition request may be a command signal, requesting a transition to the second communication network 125, input by a user desiring for use of the free mobile communication in lieu of using the fee-charging communication network. For example, when the first communication network 115 is the mobile communication network, the network transition request may be a request of transition from the mobile communication network to a wireless local network area network (WLAN), that is, the second communication network 125.

When the network transition request is received, a Wi-Fi network server 120 included in the data transmission apparatus 100 may maintain the transmitting of the downlink data to the terminal device 140, using the second communication network 125 differing from the first communication network 115.

Accordingly, the Wi-Fi network server 120 may lead the downlink data to be continuously transmitted using the free WLAN. When a network transition to the second communication network 125 is unavailable due to a difficulty in sensing the WLAN, and has an inability to sense an effectiveness of the WLAN, the Wi-Fi network server 120 may provide, to the mobile communication network server 110, a notification indicating that the network transition is impossible such that the transmitting of the downlink data may be performed using the first communication network 115.

In advance of transmitting the downlink data using the second communication network 125, the Wi-Fi network server 120 may receive information associated with an authentication from the terminal device 140, and transmit the downlink data to the terminal device 140 on which a process of a predetermined authentication is performed.

In addition, the data transmission apparatus 100 may deliver, to the terminal device 140, control information used to connect the terminal device 140 to the second communication network 125 using a channel associated with the first communication network 115. To this end, the data transmission apparatus 100 may include a control unit 130 to control the control information to be provided to the terminal device 140 using the cellular mobile communication network connected to most recently.

The control information may be information associated with the downlink data including, for example, a name of a file being downloaded, a sector of a file on which a transmission is completed, a file provider, and the like.

In an example of a delivery of the control information, the control unit 130 may deliver, to the terminal device 140, the control information using a physical downlink shared channel (PDSCH), or a third generation partnership project (3GPP) long term evolution (LTE) channel set based on a mobile communication network including the first communication network 115. Thus, the control unit 130 may establish a system for rapidly and accurately transmitting the control information used to connect the terminal device 140 to the second communication network 125 using a channel set in advance of the network transition.

In addition, the control unit 130 may deliver at least a portion of control information indicated in a field of a management frame.

The management frame may provide a function of storing, in an internal field, information associated with an access point (AP) access process by which the terminal device 140 connects to the second communication network 125. The control unit 130 may deliver, to the terminal device 140, the management frame in which the information associated with the AP access process is stored, using the channel. Subsequently, the terminal device 140 may read the field of the management frame and perform an access process to access the second communication network 125.

Accordingly, in an example embodiment, the data transmission method and the data transmission apparatus may be provided to minimize a delay occurring in a process of data transmission resulting from a network transition, and continuously exchange control information associated with an access process using a communication network unrelated to the data transmission without an occurrence of disconnection in a network liked with a heterogeneous system.

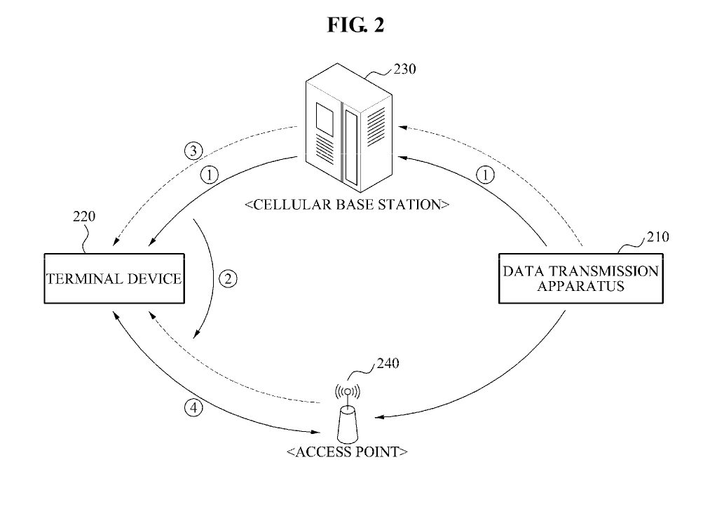

FIG. 2 is a diagram illustrating an example of a data transmission apparatus 210 according to an embodiment of the present invention.

When a terminal device transmitting and receiving data through a connection to a cellular base station attempts to transmit and receive the data based on a Wi-Fi network, a known AP access process has been performed in a conventional method.

In such an AP access process, a management frame described below may be transmitted and received between an AP and the terminal device such as a station (STA), user equipment (UE), and a terminal.

<Management Frame>

| | |
|---|---|
| Beacon | Association Request |
| Disassociation | Association Response |
| Reassociation Request | Reassociation Response |
| Probe Request | Probe Response |
| Authentication | Deauthentication |

Timing Advertisement

The management frame may include a field described below.

<A Field Included in the Management Frame>

Authentication Algorithm Number
Authentication Transaction Sequence Number

| | |
|---|---|
| Beacon interval | Capability Information |
| Current AP Address | Listen interval |
| Reason Code | Association ID(AID) |
| Status Code | Timestamp |
| Action | Dialog Token |
| DLS Timeout Value | Block Ack Parameter Set |
| Block Ack Timeout Value | DELBA Parameter Set |
| QoS Information field | SSID |
| Supported Rates | FH Parameter Set |
| DS Parameter Set | CF Parameter Set |
| TIM | IBSS Parameter Set |
| Challenge text | Country |

(Frequency) Hopping Pattern Parameters
(Frequency) Hopping Pattern Table

| | |
|---|---|
| Request | ERP Information |
| Extended Supported Rates | Power Constraint |
| Power Capability | TPC Request |
| TPC Report | Supported Channels |
| Channel Switch Announcement | Measurement Request |
| Measurement Report | Quiet |
| IBSS DFS | RSN |
| Vendor Specific | Extended Capabilities |
| BSS Load | EDCA Parameter Set |
| TSPEC | TCLAS |
| TS Delay | TCLAS Processing |
| Schedule | QoS Capability |
| HT Capabilities | HT Operation |
| Secondary Channel Offset | 20/40 BSS Coexistence |

20/40 BSS Intolerant Channel Report
Overlapping BSS Scan Parameters

| | |
|---|---|
| AP Channel Report | Neighbor Report |
| RCPI | BSS Average Access Delay |
| Antenna Information | RSNI |

Measurement Pilot Transmission Information
BSS Available Admission Capacity

| | |
|---|---|
| BSS AC Access Delay | RRM Enabled Capabilities |
| Multiple BSSID | Mobility domain |

Fast BSS Transition Information

| | |
|---|---|
| Timeout Interval | Resource Information Container |

Resource Information Container Descriptor

| | |
|---|---|
| DSE registered location | Supported Regulatory Classes |

Extended Channel Switch Announcement

| | |
|---|---|
| Management MIC | Time Advertisement |
| Association Comeback Time | Event Request |
| Event Report | Diagnostic Request |
| Diagnostic Report | Location Parameters |

Non-transmitted BSSID Capability

| | |
|---|---|
| SSID List | Multiple BSSID-Index |
| FMS Descriptor | FMS Request |
| FMS Response | QoS Traffic Capability |
| BSS Max Idle Period | TFS Request |
| TFS Response | WNM-Sleep Mode |
| TIM Broadcast Request | TIM Broadcast Response |
| Collocated Interference Report | Channel Usage |
| Time Zone | DMS Request |
| DMS Response | Destination URI |
| u-APSD Coexistence | Link Identifier |
| Wakeup Schedule | Reserved |
| Channel Switch Timing | PTI Control |
| PU Buffer Status | Interworking |
| Advertisement Protocol | Expedited bandwidth request |
| QoS Map Set | Roaming Consortium |

Emergency Alert

For the communication between the AP and the terminal device, at least a portion of information indicated in the aforementioned field may be transmitted and received, and a time for exchanging the information may be necessary.

For example, since a WLAN for the AP access process is used for a multiple access based on a carrier sense multiple access with collision avoidance (CSMA/CA), a time for occupying a channel may be necessary for transmitting and receiving a message. When an excessive number of terminals are present in a service area, a probability of an occurrence of a collision may increase, and a delay time may also increase.

The data transmission apparatus 210 may prevent an occurrence of delay using a method described below.

In the method, a terminal device 220 1) may perform data transmission and reception through a connection to a cellular base station 230, and then 2) attempt to access a WLAN such as a Wi-Fi network. In this instance, the data transmission apparatus 210 3) may transmit control information used for an access to the WLAN using a mobile communication channel set by the cellular base station 230.

In an example, when the terminal device 220 receiving a service through a connection to a mobile communication network such as a 3GPP LTE network is to access the WLAN, the data transmission apparatus 210 may deliver the control information used by the terminal device 220 to access the WLAN using a 3GPP LTE channel.

Subsequently, the terminal device 220 may access the WLAN based on the transmitted control information. The data transmission apparatus 210 4) may continuously maintain a data transmission and reception service provided to the terminal device 220 using an AP 240 when the terminal device 220 is connected to the WLAN.

The control information used for the access to the WLAN may include a portion or all of the control information indicated in the field of the management frame. A channel that the terminal device 220 uses to transmit the control information used for the access to the WLAN may be a PDSCH.

In another example, the data transmission apparatus 100 may receive acknowledgement (ACK) information in response to transmission of the downlink data using a channel associated with a fee-charging communication network, thereby reducing a delay in receiving the ACK information. When the transmission of the downlink data is performed using the second communication network 125, the control unit 130 may receive the ACK information in response to the transmitting of the downlink data using the channel.

Accordingly, a delay occurring between the transmission of the downlink data and reception of the ACK information may be minimized by using a mobile communication network for the reception of the ACK information, in lieu of a WLAN to which the terminal device 140 is currently connected.

In this example, the control unit 130 may receive the ACK information using one of a PDSCH, a physical uplink shared channel (PUSCH), a physical uplink control channel (PUCCH), and a physical hybrid automatic repeat request (HARQ) indicator channel (PHICH).

According to an example embodiment, in a network linked with a heterogeneous system, a data transmission method and apparatus may be provided to minimize a waste of time in a subscriber information filing system (SIFS) by delivering ACK information using a communication network of which a reaction speed is relatively high, in response to data transmission.

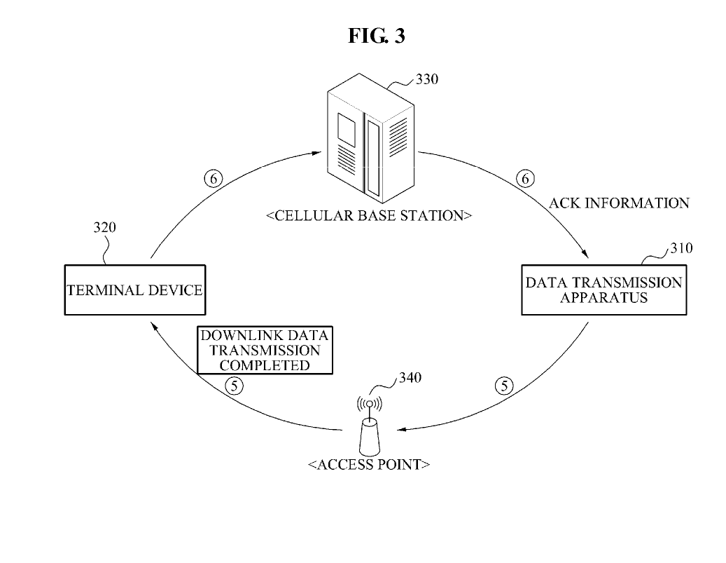

FIG. 3 is a diagram illustrating another example of a data transmission apparatus 310 according to an embodiment of the present invention.

A second communication network may refer to a WLAN based on a time-division duplex (TDD). In the second communication network, a predetermined period, for example, an SIFS of delay may occur between a reception of downlink data and a transmission of ACK information performed in response to the reception of the downlink data. Since a transmission and reception is not performed during the period of delay, wireless resources may be unnecessarily used during a corresponding period of time.

The data transmission apparatus 310 may reduce a waste of wireless resources using a transmission and reception method described below.

Referring to FIG. 3, the data transmission apparatus 310 may 5) transmit downlink data to a terminal device 320 connected to a WLAN, using an AP 340 and 6) receive ACK information from the terminal device 320 using a channel associated with a mobile communication network, for example, a mobile communication channel in response to the transmitting of the downlink data. In this instance, the terminal device 320 may also transmit, to the mobile communication channel, uplink data, for example, data to be transmitted to a cellular base station 330 or the AP 340 of the WLAN by the terminal device 320.

Depending on an embodiment, the data transmission apparatus 310 may be implemented in a reverse direction.

For example, the downlink data may be transmitted to the terminal device 320 using the mobile communication network, and the uplink data or the ACK information may be received from the terminal device 320 using the WLAN in response to the downlink data.

When the channel associated with the mobile communication network used for the receiving the ACK information is a 3GPP LTE channel, the channel may be a PDSCH, a PUSCH, a PUCCH, a PHICH, and the like.

According to an example embodiment, efficiency in a communication network may be improved by reducing time wasted during an SIFS time in the WLAN using the aforementioned method.

In another example, the data transmission apparatus 100 may support a delivery of uplink data to be performed from a terminal device in a separate time slot for each terminal device. For example, the control unit 130 may receive a scheduling request from the terminal device using a channel and, in response to the scheduling request, deliver scheduling information to the terminal device such that the uplink data is transmitted from the terminal device controlled based on the scheduling information.

For example, when the scheduling information includes time information used for occupying wireless resources, the control unit 130 may enable the uplink data to be transmitted from the terminal device in a time slot designated based on the time information.

In addition, when the scheduling information includes a parameter used for occupying the wireless resources, the control unit 130 may enable the uplink data to be received from the terminal device in a back-off delay time slot based on the parameter.

Accordingly, when the wireless resources are used, the data transmission apparatus 100 may avoid an occurrence of collision by allocating an occupancy time to each of a plurality of terminal devices without overlapping.

According to an example embodiment, in a network linked with a heterogeneous system, a data transmission method and apparatus may be provided to enable data transmission of each terminal to be performed in a systemized state without congestion by providing scheduling information used for occupying the wireless resources for each terminal.

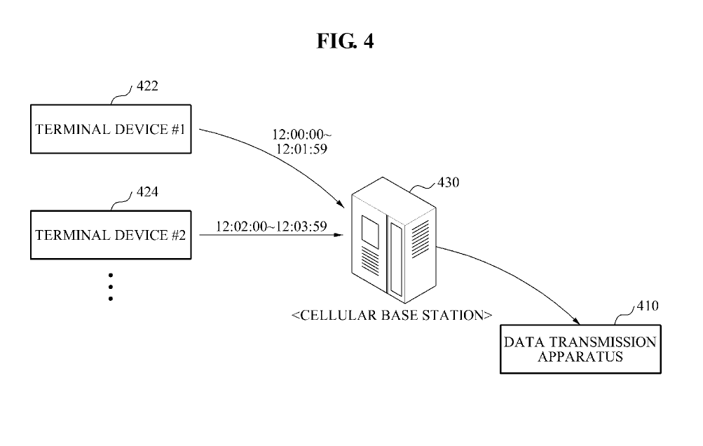

FIG. 4 is a diagram illustrating still another example of a data transmission apparatus 410 according to an embodiment of the present invention.

In a WLAN, wireless resources may be occupied through a competition. When numerous users are present in a predetermined region and thus, the users attempt to occupy the wireless resources, a collision may occur among terminal devices of the users. An occurrence of the collision may reduce efficiency of communication.

To solve this, the data transmission apparatus 410 may apply a transmission and reception method described below.

A terminal device #1 422 and a terminal device #2 424 may transmit a message including a scheduling request, to a cellular base station 430 using a mobile communication channel in advance to transmit uplink data. The data transmission apparatus 410 may receive the scheduling request from the cellular base station 430, generate scheduling information used for occupying wireless resources of the terminal device #1 422 and the terminal device #2 424, and transfer the generated scheduling information to the terminal device #1 422 and the terminal device #2 424.

The scheduling information may include time information on a time at which each of the terminal device #1 422 and the terminal device #2 424 attempts to occupy the wireless resources. For example, each of the terminal device #1 422 and the terminal device #2 424 may receive information on a time for using wireless resources, attempt to occupy the wireless resources in the time for using wireless resources, and transmit the uplink data when not in use by another user.

Referring to FIG. 4, the data transmission apparatus 410 may allocate time information “12:00:00-12:01:59” to the terminal device #1 422 and time information “12:02:00-12:04:59” to the terminal device #2 424 based on the scheduling information such that the terminal device #1 422 and the terminal device #2 424 transmit the uplink data to the data transmission apparatus 410 in a time slot designated based on the time information “12:00:00-12:01:59” and the time information “12:02:00-12:04:59”.

Accordingly, WLAN users may avoid an occurrence of a collision resulting from occupying the wireless resources.

In addition, a parameter used for a back-off delay may be another example of the scheduling information used for occupying the wireless resources of a WLAN user. The WLAN user may receive the parameter, perform the back-off delay based on the parameter, and attempt to occupy the wireless resources.

Hereinafter, descriptions about an operation performed by the data transmission apparatus in the network linked with a heterogeneous system according to an example embodiment will be provided.

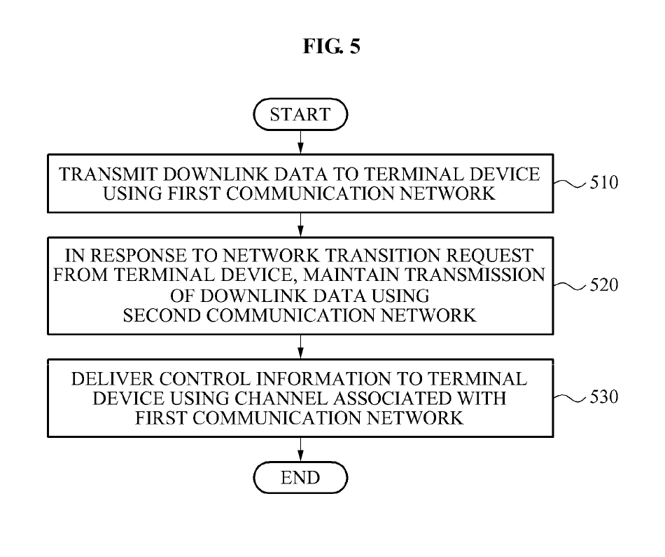

FIG. 5 is a flowchart illustrating a data transmission method in a network liked with a heterogeneous system according to an embodiment of the present invention.

The data transmission method in a network linked with a heterogeneous system according to an example embodiment may be implemented by the aforementioned data transmission apparatus 100.

Referring to FIG. 5, the data transmission apparatus 100 may be selectively connected to a first communication network 115 and a second communication network 125, and transmit downlink data to a terminal device 140. The first communication network 115 may be a fee-charging mobile communication network such as a cellular mobile communication network including a 3G network, an LTE network, and the like. The second communication network 125 may be a free mobile communication such as a Wi-Fi network including a wireless AP and the like.

In operation 510, the data transmission apparatus 100 may transmit the downlink data to the terminal device 140 using the first communication network 115. In operation 510, the data transmission apparatus 100 may be connected to the terminal device 140 and transmit data to the terminal device 140 in response to a request from the terminal device 140 in a fee-charging environment of the cellular mobile communication network.

Subsequently, the data transmission apparatus 100 may verify whether a network transition request is received from the terminal device 140 while the downlink data is being transmitted to the terminal device 140.

The network transition request may be a command signal that requests a transition to the second communication network 125 input by a user desiring to use the free mobile communication in lieu of using the fee-charging communication network. For example, when the first communication network 115 is the mobile communication network, the network transition request may be a request of transition from the mobile communication network to a wireless local network area network (WLAN), that is, the second communication network 125.

In operation 520, when the network transition request is received, the data transmission apparatus 100 may maintain the transmitting of the downlink data to the terminal device 140 using the second communication network 125 differing from the first communication network 115.

In operation 520, the data transmission apparatus 100 may lead the downlink data to be continuously transmitted using the free WLAN. When a network transition to the second communication network 125 is unavailable due to a difficulty in sensing the WLAN, and has an inability to sense an effectiveness of the WLAN, the data transmission apparatus 100 may provide, to the mobile communication network server 110, a notification indicating that the network transition is impossible such that the transmitting of the downlink data may be performed using the first communication network 115.

In advance of transmitting the downlink data using the second communication network 125, the data transmission apparatus 100 may receive information associated with an authentication from the terminal device 140, and transmit the downlink data to the terminal device 140 on which a process of a predetermined authentication is performed.

In operation 530, the data transmission apparatus 100 may deliver, to the terminal device 140, control information used to connect the terminal device 140 to the second communication network 125 using a channel associated with the first communication network 115. In operation 530, the data transmission apparatus 100 may control the control information to be provided to the terminal device 140 using the cellular mobile communication network connected to most recently.

The control information may be information associated with the downlink data including, for example, a name of a file being downloaded, a sector of a file on which a transmission is completed, a file provider, and the like.

In an example of a delivery of the control information, the data transmission apparatus 100 may deliver, to the terminal device 140, the control information using a PDSCH or a 3GPP LTE channel set using a mobile communication network including the first communication network 115. Thus, the data transmission apparatus 100 may establish a system for rapidly and accurately transmitting the control information used to connect the terminal device 140 to the second communication network 125 using a channel set in advance of the network transition.

In addition, the data transmission apparatus 100 may deliver at least a portion of control information indicated in a field of a management frame.

The management frame may provide a function of storing, in an internal field, information associated with an AP access process by which the terminal device 140 connects to the second communication network 125. The control unit 130 may deliver, to the terminal device 140, the management frame in which the information associated with the AP access process is stored, using the channel. Subsequently, the terminal device 140 may read the field of the management frame and perform an access process to access the second communication network 125.

Accordingly, in an example embodiment, the data transmission method and the data transmission apparatus may be provided to minimize a delay occurring in a process of data transmission resulting from a network transition, and continuously exchange control information associated with an access process using a communication network unrelated to the data transmission without an occurrence of disconnection in a network liked with a heterogeneous system.

In another example, the data transmission apparatus 100 may receive ACK information in response to transmission of the downlink data, using a channel associated with a fee-charging communication network, thereby reducing a delay in receiving the ACK information. When the transmission of the downlink data is performed using the second communication network 125, the control unit 130 may receive the ACK information in response to the transmission of the downlink data using the channel.

Accordingly, a delay occurring between the transmission of the downlink data and reception of the ACK information may be minimized by using a mobile communication network for the reception of the ACK information, in lieu of a WLAN to which the terminal device 140 is currently connected.

In this example, the control unit 130 may receive the ACK information using one of a PDSCH, a PUSCH, a PUCCH, and a PHICH.

According to an example embodiment, in a network linked with a heterogeneous system, a data transmission method and apparatus may be provided to minimize time wasted in an SIFS by delivering ACK information using a communication network of which a reaction speed is relatively high, in response to data transmission.

In another example, the data transmission apparatus 100 may support a delivery of uplink data to be performed from a terminal device in a separate time slot for each terminal device. For example, the data transmission apparatus 100 may receive a scheduling request from the terminal device using a channel and, in response to the scheduling request, deliver scheduling information to the terminal device such that the uplink data is transmitted from the terminal device controlled based on the scheduling information.

For example, when the scheduling information includes time information used for occupying wireless resources, the data transmission apparatus 100 may enable the uplink data to be transmitted from the terminal device in a time slot designated based on the time information.

In addition, when the scheduling information includes a parameter used for occupying the wireless resources, the data transmission apparatus 100 may enable the uplink data to be received from the terminal device in a back-off delay time slot based on the parameter.

Accordingly, when the wireless resources are used, the data transmission apparatus 100 may avoid an occurrence of collision by allocating an occupancy time to each of a plurality of terminal devices without overlapping.

According to an example embodiment, in a network linked with a heterogeneous system, a data transmission method and apparatus may be provided to enable data transmission of each terminal to be performed in a systemized state without congestion by providing scheduling information used for occupying the wireless resources for each terminal.

According to an aspect of the present invention it is possible to provide a data transmission method and apparatus to minimize a delay occurring in a process of data transmission resulting from a network transition, and continuously exchange control information associated with an access process using a communication network unrelated to the data transmission without an occurrence of disconnection in a network liked with a heterogeneous system.

According to another aspect of the present invention, it is possible to provide a data transmission method and apparatus to minimize time wasted in a subscriber information filing system (SIFS) by delivering acknowledgement (ACK) information using a communication network of which a reaction speed is relatively high, in response to data transmission in a network linked with a heterogeneous system.

According to still another aspect of the present invention, it is possible to provide a data transmission method and apparatus to perform data transmission of each terminal in a systemized state without congestion by providing scheduling information used for occupying the wireless resources for each terminal in a network linked with a heterogeneous system.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A data transmission method in a network linked with a heterogeneous system, the method comprising:
transmitting downlink data to a terminal device using a first communication network; and
delivering, in response to a network transition request from the terminal device, control information used to connect the terminal device to a second communication network, to the terminal device using a channel associated with the first communication network while maintaining the transmitting of the downlink data using the second communication network differing from the first communication network.

2. The method of claim 1, wherein when the first communication network is a mobile communication network, the network transition request is a request to transition from the mobile communication network to a wireless local network area network (WLAN) indicating the second communication network.

3. The method of claim 2, wherein the delivering comprises delivering the control information to the terminal device using a physical downlink shared channel (PDSCH) or a third generation partnership project (3GPP) long term evolution (LTE) channel set based on the mobile communication network.

4. The method of claim 1, wherein the delivering comprises delivering at least a portion of control information indicated in a field of a management frame.

5. The method of claim 1, further comprising:
receiving, when the transmitting of the downlink data to the terminal device based on the second communication network is completed, acknowledgement (ACK) information associated with the transmitting of the downlink data using the channel being completed.

6. The method of claim 5, wherein the receiving comprises receiving the ACK information using at least one of the PDSCH, a physical uplink shared channel (PUSCH), a physical uplink control channel (PUCCH), and a physical hybrid automatic repeat request (HARQ) indicator channel (PHICH).

7. The method of claim 1, further comprising:
receiving a scheduling request from the terminal device using the channel;
delivering the scheduling information to the terminal device in response to the scheduling request; and
receiving uplink data from the terminal device controlled based on the scheduling information.

8. The method of claim 7, wherein when the scheduling information includes time information used for occupying wireless resources, the receiving of uplink data comprises receiving the uplink data from the terminal device in a time slot designated based on the time information.

9. The method of claim 7, wherein when the scheduling information includes a parameter used for occupying the wireless resources, the receiving of uplink data comprises receiving the uplink data from the terminal device in a back-off delay time slot based on the parameter.

10. A data transmission apparatus comprising:
a mobile communication network server to transmit downlink data to a terminal device using a first communication network;
a wireless fidelity (Wi-Fi) network server to maintain transmission of the downlink data to the terminal device based on a second communication network differing from the first communication network in response to a network transition request of the terminal device; and
a control unit to transmit, to the terminal device, control information used to connect the terminal device to the second communication network using a channel associated with the first communication network.

11. The apparatus of claim 10, wherein when the first communication network is a mobile communication network, the network transition request is a request to transition from the mobile communication network to a wireless local area network (WLAN) indicating the second communication network.

12. The apparatus of claim 11, wherein the control unit delivers the control information to the terminal device using a physical downlink shared channel (PDSCH) or a third generation partnership project (3GPP) long term evolution (LTE) channel set based on the mobile communication network.

13. The apparatus of claim 11, wherein the control unit delivers at least a portion of control information indicated in a field of a management frame.

14. The apparatus of claim 10, wherein when the transmission of the downlink data to the terminal device using the second communication network is completed, the control unit receives acknowledgement (ACK) information associated with completion of the transmission of the downlink data using the channel.

15. The apparatus of claim 14, wherein the control unit receives the ACK information using at least one of the PDSCH, a physical uplink shared channel (PUSCH), a physical uplink control channel (PUCCH), and a physical hybrid automatic repeat request (HARQ) indicator channel (PHICH).

16. The apparatus of claim 10, wherein the control unit receives a scheduling request from the terminal device using the channel, delivers the scheduling information to the terminal device in response to the scheduling request, and receives uplink data from the terminal device controlled based on scheduling information.

17. The apparatus of claim 16, wherein when the scheduling information includes time information for occupying wireless resources, the control unit receives the uplink data from the terminal device in a time slot designated based on the time information.

18. The apparatus of claim 16, wherein when the scheduling information includes a parameter used for occupying wireless resources, the control unit receives the uplink data from the terminal device in a back-off delay time slot based on the parameter.
